(19) United States
(12) Patent Application Publication
(10) Pub. No.: US 2003/0084917 A1
(43) Pub. Date: May 8, 2003

(54) Method and device for cleaning metallic articles

(75) Inventors: Ralf Pape, Porta Westfalica (DE); Heinz-Gerd Walter, Hurth (DE); Thomas Troster, Salzkotten (DE); Jurgen Krogmeier, Hovelhof (DE); Johannes Boke, Aerzen (DE)

Correspondence Address: Henry M. Feiereisen, Suite 3220, 350 Fifth Avenue, New York, NY, 10118, US

(73) Assignee: Benteler Automobiltechnik GmbH & Co. KG, Paderborn (DE)

(21) Appl. No.: 10/290,107

(22) Filed: Nov. 7, 2002

(30) Foreign Application Priority Data
Nov. 8, 2001 (DE) 101 54 922.9

(51) Int. Cl. B08B 3/12

(52) U.S. Cl. 134/1; 134/3; 134/32; 134/184; 134/201; 510/255

(57) ABSTRACT

In a method of cleaning a metallic article, in particular for removing oxide deposits, whereby the metallic article is made of a hardenable steel having a carbon content of at least 0.1% by weight and is at least partially hardened, the metallic article is placed in a vessel containing a liquid cleaning agent with a pH value in the range of 4 to 8, and exposed to sound waves.

### CROSS-REFERENCES TO RELATED APPLICATIONS

This application claims the priority of German Patent Application Serial No. 101 54 922.9, filed Nov. 8, 2001, pursuant to 35 U.S.C. 119(a)-(d), the disclosure of which is incorporated herein by reference.

### BACKGROUND OF THE INVENTION

The present invention relates to a method and device for cleaning metallic articles, in particular for removing oxide deposits.

In general, metals should be thoroughly cleansed and degreased before they are subjected to a further processing step such as galvanizing, painting, enameling or coating. Cleaning agents in powdery and/or liquid form are typically used in immersion or spraying processes to realize the cleaning action.

Pickling is oftentimes used to treat the metal surface and refers in general to a chemical removal of scales and rust through use of mineral acids. Steel is predominantly treated with pickling acids such as hydrochloric acid, sulfuric acid or nitric acid. Currently, hydrochloric acid is increasingly used as pickling acid because the surfaces of low-alloy steels can be also cleansed. Pickling of standard steel in order to remove rust or scale involves the use of either pre-configured products or inhibitors which are added to the pickling acids. These types of inhibitors are chemical substances which break up only deposits or contaminants from the metal surface, without affecting the metal as such. The addition of such inhibitors significantly decreases a metal removal during the pickling process.

During pickling process, the pickling agent reacts with the unprotected metal surface to produce hydrogen which rises in the pickling bath. This is problematic because hydrogen is absorbed by metal, in particular steel, resulting in a material embrittlement and thus to a stress corrosion. Although inhibitors hamper the removal of metal, it is not clear when a hydrogen absorption by metal is accelerated or decelerated. Therefore, manufacturers of inhibited pickling degreasers provide pickling agents which are prepared specifically for the application at hand, for example, tenside/inhibitors mixtures optimized to cause minimal hydrogen embrittlement. Still, highly critical steel parts, like, e.g., high-strength steel, can be subjected only momentarily to the pickling bath to prevent hydrogen embrittlement.

German utility model no. DE 298 05 737 U1 discloses a method and device for removing oxide layers on articles by using a liquid medium which is contained in a receptacle and suitable to dissolve grease, dirt and oxide layers, and by exposing the medium to oscillations for cleansing, degreasing and clearing the oxide layer on the soiled article surface.

To date, chemical processes, such as pickling, cannot be used in connection with partially or completely hardened articles of undercarriages or safety structures because of the risk of hydrogen embrittlement that leads to brittle steel products. When the steel has a very high hardness, the acid treatment in a pickling bath is therefore not an option. Steels of low hardness require the addition of an inhibitor as well as a subsequent temperature treatment for removing possible hydrogen residues.

Other processes, involving abrasive effect, such as sand blasting or shot-peening, entail the risk that the articles of slight wall thickness become distorted. Moreover, these abrasive processes are unsuitable, when the articles have undercuts or are formed with hollows.

It would therefore be desirable and advantageous to provide an improved method and device for cleansing metallic articles, to obviate prior art shortcomings and to clean steels without encountering hydrogen embrittlement.

### SUMMARY OF THE INVENTION

According to one aspect of the present invention, in a method of cleaning a metallic article, in particular for removing oxide deposits, which article is made of a hardenable steel having a carbon content of at least 0.1% by weight and is at least partially hardened, the metallic article is placed in a vessel containing a liquid cleaning agent having a pH value in the range of 4 to 8, and exposed to sound waves.

The present invention resolves prior art problems by combining the use of high-energy sound waves with a moderately heated cleaning agent of particular formulation with a higher pH value in the range from 4 to 8. As a consequence of the higher pH value, hydrogen development is significantly reduced during the cleaning process. The combination of high-energy sound waves with specially formulated cleaning agent thus allows a cleaning of high-strength, metallic articles which have decreased resistance to hydrogen embrittlement. Hardenable steels with a carbon content of at least 0.1% by weight can be cleaned, in particular also high-strength steels which have been at least partially hardened.

According to another feature of the present invention, the liquid cleaning agent may be an aqueous solution with a pH value in the range of 5 to 7.

According to another feature of the present invention, the liquid cleaning agent may contain the following components, by weight percent:

a) 1 to 3% of an organic carboxylic acid selected from the group consisting of polybasic carboxylic acid with 3 to 10 carbon atoms, and hydroxy carboxylic acid with 3 to 10 carbon atoms, or their anions,

b) 0.2 to 2% of an organic phosphoric acid selected from the group consisting of phosphonic acid with at least two phosphonic acid groups, and phosphonic carboxylic acid, and their anions,

c) 0.05 to 0.5% of a tenside,

d) 0.001 to 0.005% of a pickling inhibitor, and

e) the balance to 100% being water.

Suitably, the cleaning agent is heated to a temperature in the range of up to 100° C.

According to another feature of the present invention, the sound waves may have a frequency between 10 kHz and 100 kHz.

According to another feature of the present invention, the article can be placed in the vessel continuously or intermittently. In other words, the articles to be cleaned can be placed into the cleansing bath individually or in baskets or racks holding an array of articles. Placement of the articles in the baskets or racks may be carried out manually, or by a robot. Of course, the application of an automatic belt or chain drive may also be used for the process so long as the articles being cleaned are retained for a suitable retention time in the cleansing bath. The articles being cleaned may be placed in the vessel in standing, suspended or lying disposition.

According to another feature of the present invention, at least one vibrating element may be provided for generating the sound waves, with the vibrating element having a polygonal or circular cross section. Examples of vibrating elements include a flat oscillator, e.g. in the shape of a block, or a bar oscillator in the form of a cylinder. Depending on the configuration of the articles being cleaned, several vibrating elements may be arranged in the vessel. The vibrating element or elements may hereby cover at least part of an inner wall surface of the vessel, or may form one or more inner surfaces of the vessel. Another example involves the integration of a vibrating element in the vessel bottom. Of course, the vibrating element or elements may also be disposed in the center of the vessel or at any other suitable location within the vessel.

According to another feature of the present invention, the vessel may include a deflection assembly for concentrating the sound waves on the article. In this way, the cleaning effect is enhanced. A further improvement of the cleaning effect can be realized by moving the article and the vibrating element relative to one another. For example, the article may be reversed or rotated in the vessel with respect to the stationary vibrating element to realize an optimum cleaning effect of all areas of the article. When the article is bulky, the vibrating element may be moveable instead relative to the stationary article.

The application of the sound waves is able to remove a hydrogen buildup as a result of a chemical reaction on the article surface to thereby prevent a hydrogen embrittleness of the article.

According to another aspect of the present invention, a cleaning device for cleaning a metallic article having a carbon content of at least 0.1% by weight and at least partially hardened, includes a vessel containing a liquid cleaning agent having a pH value in the range of 4 to 8; and at least one vibrating element for exposing the article in the vessel to sound wave for breaking up deposits on the article and preventing a hydrogen buildup.

### BRIEF DESCRIPTION OF THE DRAWING

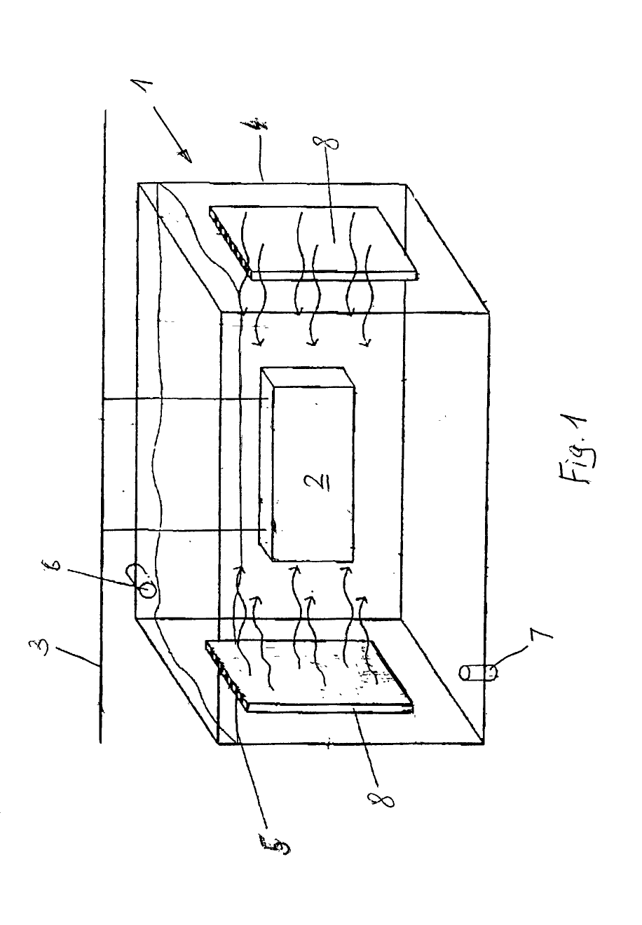

Other features and advantages of the present invention will be more readily apparent upon reading the following description of currently preferred exemplified embodiments of the invention with reference to the accompanying drawing, in which the sole FIG. 1 shows a schematic perspective illustration of a basic configuration of a cleaning device according to the present invention.

### DETAILED DESCRIPTION OF PREFERRED EMBODIMENTS

Turning now to FIG. 1, there is shown a schematic perspective illustration of a basic configuration of a cleaning device according to the present invention, generally designated by reference numeral 1, for cleaning at least one metallic article 2 from oxide deposits in particular. The metallic article 2 is made of steel which is at least partially hardened and has a carbon content of at least 0.1% by weight. In the non-limiting example of FIG. 1, the steel article 2 is placed by an overhead transport system 3 into a vessel 4 of the cleaning device 1 and moved away, once the cleaning process is concluded. The transport system 3 is shown here only by way of example and not described in more detail for sake of simplicity because it does not form part of the present invention. Of course, other transport systems, such as robots or even manual maneuvering of the steel article 2 may be used as well without departing from the spirit of the present invention. It will be appreciated by persons skilled in the art that the illustration of a single article 2 in the vessel 4 is done by way of example only. Of course, the vessel 4 may be charged with a plurality of steel articles which can be supplied continuously or intermittently.

The vessel 4 is filled with a liquid cleaning agent to a level 5 through an inlet port 6 and may be discharged through an outlet port 7, when being spent. The cleaning agent has a composition wit a pH value in the range of 4 to 8, preferably an aqueous solution with a pH value of 5 to 7. Currently preferred is an aqueous cleaning agent having the following components:

a) 1 to 3% of an organic carboxylic acid selected from the group consisting of polybasic carboxylic acid with 3 to 10 carbon atoms, and hydroxy carboxylic acid with 3 to 10 carbon atoms, or their anions,

b) 0.2 to 2% of an organic phosphoric acid selected from the group consisting of phosphonic acid with at least two phosphonic acid groups, and phosphonic carboxylic acid, and their anions,

c) 0.05 to 0.5% of a tenside,

d) 0.001 to 0.005% of a pickling inhibitor, and

e) the balance to 100% being water.

Suitably, the cleaning agent is kept at a temperature of up to 100° C. within the vessel 4 by a suitable heating system (not shown).

As shown in FIG. 1 by way of example, a plurality of sound transmitters or vibrating elements 8 are attached to the vessel 4 and emit low-frequency sound of high intensity within the vessel 4, as indicated by the arrows. The vibrating elements 8 are operated in a frequency range of 10 kHz to 100 kHz for effectively breaking up oxide deposits on the article 2, without encountering a hydrogen build up that may cause hydrogen embrittlement. The frequency is, of course, selected in dependence on the type of deposits in a particular application.

In the exemplified embodiment of FIG. 1, the vibrating elements 8 are attached to opposite sidewalls of the vessel 4 and include several oscillating bars which may have rectangular, square or circular cross section. The vibrating elements 8 cover here areas of the inside surface of the sidewalls. Of course, the vibrating elements 8 may also form part of the sidewalls themselves, or may be integrated or mounted to the bottom of the vessel 4, or may be positioned in the center of or any other location in the vessel 4. In this context, reference is made to afore-mentioned German utility model no. DE 298 05 737 U1, the disclosure of which is incorporated herein by reference.

Although not shown in detail, the cleaning device 1 may also include a deflection assembly, e.g. baffles, by which the sound waves can be concentrated in the direction of the article 2. Also, a drive may be incorporated in the vessel 4 to move and/or to turn the article 2 relative to the stationary vibrating elements 8. Of course, the arrangement of the article 2 and the vibrating elements 8 may also be such that the vibrating elements are moveable and/or rotatable relative to the stationary article, e.g. in situations when the article 2 is very heavy and bulky.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method of cleaning a metallic article, in particular for removing oxide deposits, whereby the metallic article is made of a hardenable steel with a carbon content of at least 0.1% by weight and is at least partially hardened, said method comprising the steps of placing the metallic article in a vessel containing a liquid cleaning agent having a pH value in the range of 4 to 8; and exposing the article to sound waves

2. The method of claim 1, wherein the liquid cleaning agent is an aqueous solution with a pH value in the range of 5 to 7.

3. The method of claim 1, wherein the liquid cleaning agent contains the following components, by weight percent:
a) 1 to 3% of an organic carboxylic acid selected from the group consisting of polybasic carboxylic acid with 3 to 10 carbon atoms, and hydroxy carboxylic acid with 3 to 10 carbon atoms, or their anions,
b) 0.2 to 2% of an organic phosphoric acid selected from the group consisting of phosphonic acid with at least two phosphonic acid groups, and phosphonic carboxylic acid, and their anions,
c) 0.05 to 0.5% of a tenside,
d) 0.001 to 0.005% of a pickling inhibitor, and
e) the balance to 100% being water.

4. The method of claim 1, and further comprising the step of controlling the cleaning agent to a temperature in the range of up to 100° C.

5. The method of claim 1, wherein the sound waves have a frequency of 10 kHz to 100 kHz.

6. The method of claim 1, wherein the article is placed in the vessel continuously or intermittently.

7. The method of claim 1, and further comprising the step of providing at least one vibrating element for generating the sound waves, with the vibrating element having a configuration selected from the group consisting of polygonal cross section and circular cross section.

8. The method of claim 7, wherein the vibrating element covers at least part of an inner wall surface of the vessel.

9. The method of claim 7, wherein the vibrating element forms an inner surface of the vessel.

10. The method of claim 1, wherein the vessel includes means for concentrating the sound waves on the article.

11. The method of claim 7, and further comprising the step of moving the article and the vibrating element relative to one another.

12. The method of claim 1, wherein the sound waves remove a hydrogen buildup on a surface of the article as a result of a chemical reaction to thereby prevent a hydrogen embrittlement of the article.

13. A cleaning device for cleaning a metallic article having a carbon content of at least 0.1% by weight and at least partially hardened, comprising:
a vessel containing a liquid cleaning agent having a pH value in the range of 4 to 8; and
at least one vibrating element for exposing the article in the vessel to sound wave for breaking up deposits on the article and preventing a hydrogen buildup.

14. The cleaning device of claim 13, wherein the liquid cleaning agent is an aqueous solution with a pH value in the range of 5 to 7.

15. The cleaning device of claim 13, wherein the liquid cleaning agent contains the following components, by weight percent:
a) 1 to 3% of an organic carboxylic acid selected from the group consisting of polybasic carboxylic acid with 3 to 10 C-atoms or their anions, and hydroxycarboxylic acid with 3 to 10 C-atoms or their anions,
b) 0.2 to 2% of an organic phosphoric acid selected from the group consisting of phosphonic acid with at least two phosphonic acid groups, and phosphonic carboxylic acid, and their anions,
c) 0.05 to 0.5% of a tenside,
d) 0.001 to 0.005% of a pickling inhibitor, and
e) the balance to 100% being water.

16. The cleaning device of claim 13, wherein the vibrating element produces sound waves at a frequency of 10 kHz to 100 kHz.
